(19) United States
(12) Patent Application Publication
(10) Pub. No.: US 2008/0264563 A1
(43) Pub. Date: Oct. 30, 2008

(54) Apparatus and Method to Enable Easy Removal of One Substrate from Another for Enhanced Reworkability and Recyclability

(76) Inventors: Joseph Kuczynski, Rochester, MN (US); Donald D. Severson, Chatfield, MN (US); Kevin Albert Splittstoesser, Stewartville, MN (US); Timothy Jerome Tofil, Rochester, MN (US); Paul Alan Vermilyea, Rochester, MN (US)

Correspondence Address: IBM CORPORATION;ROCHESTER IP LAW DEPT. 917, 3605 HIGHWAY 52 NORTH, ROCHESTER, MN, 55901-7829, US

(21) Appl. No.: 11/740,350

(22) Filed: Apr. 26, 2007

(51) Int. Cl. B29C 63/00

(52) U.S. Cl. 156/344; 428/40.1

(57) ABSTRACT

A method and apparatus enables easy removal of a first substrate (e.g., a label, EMC gasket, etc.) from a second substrate (e.g., a cover of a computer enclosure) for enhanced reworkability or recyclability. An adhesive layer affixes the substrates to each other. A coating that includes a dewetting agent (DA) is interposed between the second substrate and the adhesive layer. Removal is facilitated by applying heat and/or pressure to activate the DA. Preferably, the DA thermally decomposes to form gaseous products at a predefined temperature. Heat may be applied through one or more of the substrates to drive the DA to decomposition, which forms bubbles that lift the first substrate relative to the second substrate. Optionally, the DA may be encapsulated in microspheres. For example, the DA may be silicone oil and/or an adhesive solvent encapsulated in microspheres and may be activated by applying pressure sufficient to crush the microspheres.

### BACKGROUND OF THE INVENTION

1. Field of Invention

The present invention relates in general to the fields of removability, reworkability and recyclability. More particularly, the present invention relates to a mechanism for enabling a first substrate (e.g., a label, an EMC gasket, etc.) to be easily removed from a second substrate (e.g., a cover of a computer enclosure) for enhanced reworkability or recyclability.

2. Background Art

Labels are applied to a wide variety of items. For example, labels are frequently attached to products, such as computers and other electronic devices, for purposes of information, safety and security. Typically, an adhesive layer permanently affixes the label to the product to prevent the label from falling off or being removed from the product. For example, the use of pressure sensitive adhesive (PSA) labels for such purposes is well known in the art. Typically, the pressure sensitive adhesives used on these labels are extremely tenacious and tend to exhibit exceptional adhesion well beyond the lifetime of the product. Removable labels, i.e., labels provided with a removable adhesive layer possessing temporary as opposed to permanent bonding characteristics, are known in the art but are typically not used because of the increased likelihood that such labels will fall off the product and because such labels undesirably enable inappropriate removal by the user. For example, it is generally undesirable for a user to remove a safety label from a cover of a computer enclosure.

Hence, labels that are permanently affixed to the product are typically preferred from a product use perspective. From the recycling perspective, however, labels that are permanently affixed to products are problematic. Typically, the label must be removed from the product before it is possible to recycle the label-bearing part of the product. Generally, the removal of permanently affixed labels is a difficult and time consuming task and often results in unsatisfactory results, i.e., remnants of labels and/or adhesive residue may remain on the product. Contamination by the label remnants and/or adhesive residue makes it practically impossible to recycle products bearing permanently affixed labels. The wasteful and undesirable practice of burying the label-bearing parts of such products in landfills is often the only available disposal technique. Depending on the composition of the label-bearing parts, incineration may be an available alternative disposal technique, but generally is also a wasteful and undesirable practice.

Although described in the context of label removal, the problem discussed above also exists in the more general context of removing one substrate from another. For example, a similar problem exists in the context of removing a first substrate from a second substrate for purposes such as recycling, reworkability, and the like. In one illustrative example, an electromagnetic compatibility (EMC) gasket is often utilized between a cover and a frame/housing of an electronic device. The EMC gasket is typically adhered to at least one of the cover and the frame/housing and must be completely removed from a defective electronic device to provide reworkablity to that device during manufacture. Typically, however, the removal of such EMC gaskets is a difficult and time consuming task and often results in unsatisfactory results, i.e., remnants of EMC gaskets and/or adhesive residue may remain on the defective electronic device. Again, the wasteful and undesirable practice of burying such defective electronic devices in landfills is often the only available disposal technique. Depending on the composition of such devices, incineration may be an available alternative disposal technique, but generally is also a wasteful and undesirable practice.

It is known to use a thermo-foaming agent in the composition of a pressure sensitive adhesive layer of a PSA label. The thermo-foaming agent, which is capable of being foamed when heated, reduces the adhesive force of the adhesive layer when subjected to heating. For example, U.S. Pat. No. 6,903,898 B2, entitled “PRESSURE-SENSITIVE ADHESIVE LABEL FOR HARD DISK DRIVE”, issued on Jun. 7, 2005 to Nonaka et al. discloses the use of one or more kinds of thermo-expandable microspheres within a pressure sensitive adhesive layer of a PSA label for a hard disk drive (HDD). Unfortunately, the incorporation of thermo-foaming agents into the composition of the adhesive layer of a PSA label necessitates the purchase of non-conventional labels, which may be unavailable or cost prohibitive.

Therefore, a need exists for an enhanced mechanism for enabling a first substrate to be easily removed from a second substrate for enhanced reworkability during manufacture or recyclability at a product's end-of-life.

### SUMMARY OF THE INVENTION

According to the preferred embodiments of the present invention, a first substrate (e.g., a label, EMC gasket, etc.) is easily removed from a second substrate (e.g., a cover of a computer enclosure) for enhanced reworkability or recyclability. The substrates are affixed to each other by an adhesive layer. A coating that includes a dewetting agent is interposed between the second substrate and the adhesive layer. Removal of the first substrate from the second substrate is facilitated by applying heat and/or pressure to activate the dewetting agent. Preferably, the dewetting agent thermally decomposes to form gaseous products at a predefined temperature. Heat may be applied through one or more of the substrates to drive the dewetting agent to decomposition, which forms bubbles that lift the first substrate relative to the second substrate. Optionally, the dewetting agent may be encapsulated in microspheres. For example, the dewetting agent may be silicone oil and/or an adhesive solvent encapsulated in microspheres and may be activated by applying pressure sufficient to crush the microspheres.

### BRIEF DESCRIPTION OF THE DRAWINGS

The preferred exemplary embodiments of the present invention will hereinafter be described in conjunction with the appended drawings, where like designations denote like elements.

FIG. 1 is a cross-sectional view of a label affixed to a cover of a computer enclosure, wherein the cover includes a coating having a dewetting agent according to the preferred embodiments of the present invention.

FIG. 2 is a top perspective view of the label affixed to the cover of the computer enclosure shown in FIG. 1, wherein the cover includes a coating having a dewetting agent according to the preferred embodiments of the present invention.

FIG. 3 is a cross-sectional view of the coating applied to the cover of the computer enclosure shown in FIG. 1, prior to the application of the label to the cover.

FIG. 4 is a cross-sectional view of a label affixed to a cover of a computer enclosure, wherein the label includes a coating having a dewetting agent according to the preferred embodiments of the present invention.

FIG. 5 is a cross-sectional view of the coating applied to the label shown in FIG. 4, prior to the application of the label to the cover of the computer enclosure.

FIG. 6 is a cross-sectional view of an electromagnetic compatibility (EMC) gasket affixed to a cover of a computer enclosure, wherein a coating having a dewetting agent is interposed between the gasket's adhesive layer and the cover according to the preferred embodiments of the present invention.

FIG. 7 is flow diagram illustrating a method for applying a label to a cover of a computer enclosure, wherein a coating having a dewetting agent is interposed between the label's adhesive layer and the cover according to the preferred embodiments of the present invention.

FIG. 8 is flow diagram illustrating a method for removing a label from a cover of a computer enclosure by activating a dewetting agent in a coating interposed between the label's adhesive layer and the cover according to the preferred embodiments of the present invention.

### DETAILED DESCRIPTION OF THE PREFERRED EMBODIMENTS

1.0 Overview

In accordance with the preferred embodiments of the present invention, a first substrate (e.g., a label, EMC gasket, etc.) is easily removed from a second substrate (e.g., a cover of a computer enclosure) for enhanced reworkability or recyclability. The substrates are affixed to each other by an adhesive layer. A coating that includes a dewetting agent is interposed between the second substrate and the adhesive layer. Removal of the first substrate from the second substrate is facilitated by applying heat and/or pressure to activate the dewetting agent. Preferably, the dewetting agent thermally decomposes to form gaseous products at a predefined temperature. Heat may be applied through one or more of the substrates to drive the dewetting agent to decomposition, which forms bubbles that lift the first substrate relative to the second substrate. Optionally, the dewetting agent may be encapsulated in microspheres. For example, the dewetting agent may be silicone oil and/or an adhesive solvent encapsulated in microspheres and may be activated by applying pressure sufficient to crush the microspheres.

2.0 Detailed Description

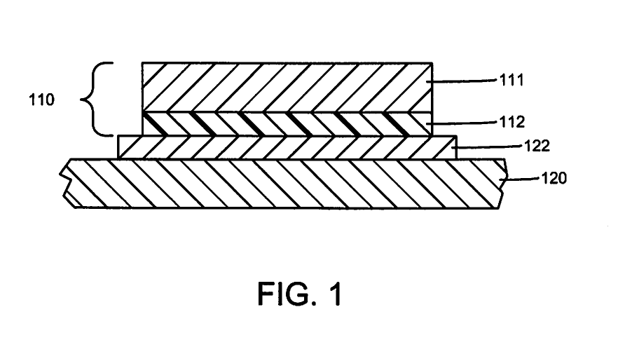

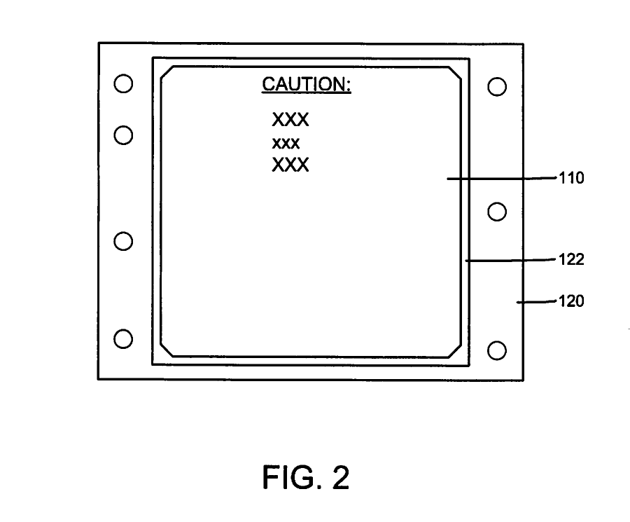

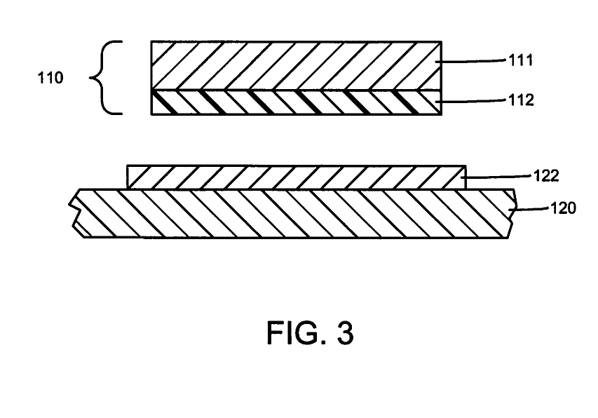

Reference is now made to FIGS. 1-3. FIG. 1 illustrates, in a cross-sectional view, a label 110 affixed to a cover 120 of a computer enclosure, wherein the cover 120 includes a coating 122 having a dewetting agent according to the preferred embodiments of the present invention. FIG. 2 illustrates, in a top perspective view, the label 110 affixed to the cover 120 of the computer enclosure. FIG. 3 illustrates, in a cross-sectional view, the coating 122 applied to the cover 120 of the computer enclosure, prior to the application of the label 110 to the cover 120.

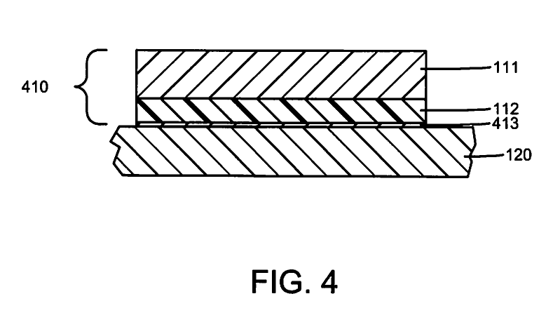

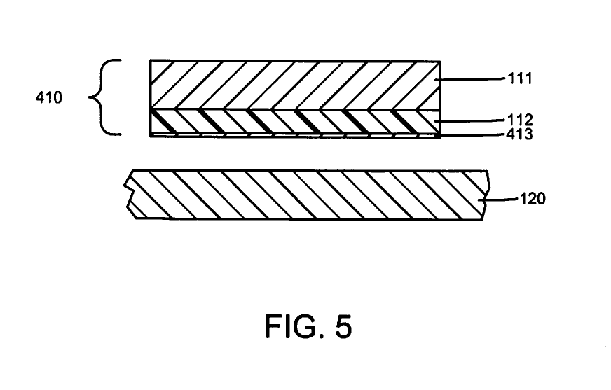

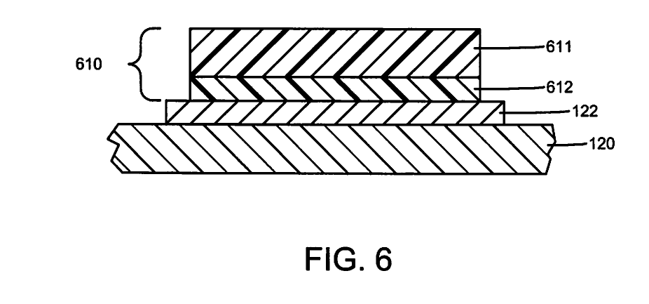

In the illustrative embodiment shown in FIGS. 1-3, the coating 122 is applied at the interface between a label and a cover of a computer enclosure. However, the applicability of the present invention is not limited to either labels or covers of computer enclosures. One skilled in the art will appreciate that a coating having a dewetting agent in accordance with the preferred embodiments of the present invention may be applied at the interface between any two substrates. More generally, a coating having a dewetting agent in accordance with the preferred embodiments of the present invention (e.g., the coating 122 in FIG. 1-3) may be thought of as a “primer” coating that is applied between at least a portion of a surface of a substrate (e.g., the cover 120 in FIGS. 1-6) and at least a portion of a surface of another substrate (e.g., the label 110 in FIGS. 1-3, the label 410 in FIGS. 4-5, or an electromagnetic compatibility (EMC) gasket in FIG. 6) for the purpose of facilitating the removal of latter substrate from the former substrate at a product's end-of-life.

Conventional adhesion primers are routinely used to enhance the adhesion of various adhesives to low surface energy substrates. Conventional adhesion primers are typically applied to at least one of the surfaces of the low surface energy substrate via any of a number of application methods (e.g., brush, roller, spray, dip, and the like). Additionally, conventional adhesion primers are generally cast from a suitable solvent, one that provides adequate solubility for the primer yet rapidly evaporates. In this fashion, a conventional adhesion primer is applied directly at the interface between the substrate and the adhesive. The preferred embodiments of the present invention use a similar approach, namely the application of a material at an interface between a substrate and an adhesive to control adhesion at the interface.

However, unlike conventional adhesion primers, in accordance with the preferred embodiments of the present invention, the applied material is chosen to selectively enhance dewetting/debonding of an adhesive at the interface, i.e., between a substrate (e.g., the cover 120 in FIGS. 1-6) and an adhesive layer of another substrate (e.g., the label 110 in FIGS. 1-3, the label 410 in FIGS. 4-5, or an electromagnetic compatibility (EMC) gasket described below with reference to FIG. 6). This dewetting/debonding material is henceforth referred to herein simply as a “dewetting agent”.

According to the preferred embodiments of the present invention, the dewetting agent is solublized in a suitable solvent and then coated directly onto one or both of the substrates. In accordance with the preferred embodiments of the present invention, the dewetting agent must remain inactive (until activated through, for example, the application of heat and/or pressure) as well as exhibit no or little effect on adhesion at the interface. In this regard, the coating preferably includes a relatively low concentration of the dewetting agent and is applied directly over a region of a first substrate (e.g., a cover of a computer enclosure) where an adhesive layer of a second substrate (e.g., a PSA label) is to be applied. This arrangement, for example, exhibits no or little effect on adhesion of the label 110 to the cover 120 prior to actuation of the dewetting agent but yet, upon actuation of the dewetting agent, facilitates the removal of the label 110 from the cover 120 without leaving adhesive residue from the label's adhesive layer 112 on the cover 120.

In accordance with the preferred embodiments of the present invention, prior to application of the label 110, the cover 120 of the computer enclosure is coated with a dewetting agent cast from a suitable solvent. The coating 122 may be, for example, applied via any of a number of application methods (e.g., brush, roller, spray, dip, and the like). Preferably, the concentration of the dewetting agent in the solvent is selected to facilitate application of the coating 122 to the cover 120 of the computer enclosure, as well as to adequately minimize the time required for the solvent to evaporate. The concentration of the dewetting agent in the solvent is preferably within the range of approximately 1.0-20.0 wt %, and more preferably, within the range of approximately 5.0-10.0 wt %. In addition, the solvent may also contain one or more other constituents, such as accelerators, catalysts, activators, etc. Preferably, the thickness of the coating 122, as well as the dewetting agent and any other constituent, if any, in the coating 122 is selected to facilitate removal of the label when the dewetting agent is activated but yet not interfere with the adhesion of the label when the dewetting agent has not yet been activated. The coating 122 is applied so as to have a thickness preferably within the range of approximately 0.1-25 μm once the solvent has evaporated, and more preferably, within the range of approximately 0.5-10.0 μm.

The dewetting agent may be selected from any number of materials that thermally decompose to form gaseous products at predefined trigger temperatures. The gaseous decomposition products effectively serve to form bubbles at the interface thereby “lifting” the label 110 from the cover 120 of the computer enclosure. Such dewetting agents (i.e., dewetting agents that thermally decompose to form gaseous products at predefined trigger temperatures) may be cast directly as such from a suitable solvent or, optionally, such dewetting agents may be encapsulated in microspheres (which are also referred to as “microcapsules”), which are then cast from a suitable solvent to form the coating 122. In the latter case, at the predefined trigger temperature, the gaseous decomposition products escape from the shells of the microspheres and effectively serve to form bubbles at the interface thereby “lifting” the label 110 from the cover 120 of the computer enclosure. Hence, the shells of the microspheres are made of one or more materials that allow the gaseous decomposition products to escape when the dewetting agent is heated to the predefined trigger temperature. Suitable materials for the shells of the microspheres include urea formaldehyde, vinylidene chloride-acrylonitrile copolymer, polyvinyl alcohol, polyvinyl butyral, polymethylmethacrylate, polyacrylonitrile, polyvinylidene chloride, polysulfone, etc. The dewetting agents are encapsulated within the shells to form microcapsules using techniques known to those skilled in the art, such as a coacervation method, an interfacial polymerization method, or an in-situ polymerization method. For example, the microcapsules may be produced by in situ polymerization of urea formaldehyde shells around the dewetting agent.

In another embodiment, the dewetting agent may be silicone oil and/or an adhesive solvent (e.g., a PSA solvent such as ethyl acetate, toluene, xylene, acetone, or suitable combinations thereof) encapsulated in microspheres of crush strengths greater than that required to apply the label. At the product's end-of-life, pressure is applied (e.g., by a weighted roller) to the label crushing the shells of the microspheres and releasing the silicone oil and/or adhesive solvent which decreases the bond strength of the label 120. Hence, the shells of the microspheres are made of one or more materials that allow the silicone oil and/or the adhesive solvent to escape when a predefined crush strength is reached. Suitable materials for the shells of the microspheres include urea formaldehyde, vinylidene chloride-acrylonitrile copolymer, polyvinyl alcohol, polyvinyl butyral, polymethylmethacrylate, polyacrylonitrile, polyvinylidene chloride, polysulfone, etc. The silicone oil and/or the adhesive solvent is encapsulated within the shells to form microcapsules using techniques known to those skilled in the art, such as a coacervation method, an interfacial polymerization method, or an in-situ polymerization method. For example, the microcapsules may be produced by in situ polymerization of urea formaldehyde shells around the silicone oil and/or the adhesive solvent.

In yet another embodiment, the dewetting agent may be a gas, such as low boiling point hydrocarbons such as isobutene or isopentane, any inert gas such as helium or nitrogen, or air encapsulated in expandable microspheres. Hence, in this embodiment, the coating 122 is loaded with expandable, gas-filled microspheres. At elevated temperatures, the gas in the gas-filled microspheres expands thereby decreasing the bond strength of the label 110. Hence, the shells of the microspheres are made of one or more materials that allow the gas in the gas-filled microspheres to expand at elevated temperatures. Suitable materials for the shells of the microspheres include urea formaldehyde, vinylidene chloride-acrylonitrile copolymer, polyvinyl alcohol, polyvinyl butyral, polymethylmethacrylate, polyacrylonitrile, polyvinylidene chloride, polysulfone, etc. The gas is encapsulated within the shells to form microcapsules using techniques known to those skilled in the art, such as a coacervation method, an interfacial polymerization method, or an in-situ polymerization method. For example, the microcapsules may be produced by in situ polymerization of urea formaldehyde shells around the gas.

Commercially available products suitable as dewetting agents that thermally decompose to form gaseous products at predefined trigger temperatures include plastic foaming agents such as azo compounds (e.g., azodicarbonamide blowing agents) and sulfonyl hydrazides (e.g., one or more of the sulfonylhydrazide compounds sold commercially under the tradename “Celogen” by Chemura Corporation (formerly Crompton Corp.), located in Middlebury, Conn.). Azo compounds bear the functional group R—N═N—R′, in which R and R′ is either alkyl or aryl. Azo compounds derive their name from the N═N group, which is often referred to as an azo. In general, any compound that thermally decomposes to gaseous products in a desired temperature window is suitable for as the dewetting agent. For example, calcium oxalate decomposes by loss of water (as steam) at elevated temperature and hence is a suitable dewetting agent.

Preferably, a solvent is selected to provide adequate solubility for the dewetting agent and to exhibit sufficiently rapid evaporation. Suitable solvents for sulfonyl hydrazides, for example, such as Celogen OT (which is a low temperature sulfonylhydrazide that decomposes at a temperature 160° C. and is commercially available from Chemura Corporation) include both strong acids and bases. Strong acids suitable as solvents for Celogen OT, for example, include the general mineral acids and strong organic acids such as trifluoracetic acid. Strong bases suitable as solvents for Celogen OT, for example, include NaOH, KOH, and alcoholic KOH. Alternatively, the dewetting agent may simply be dispersed in a suitable, fast-drying solvent and applied as a dispersion.

The temperature at which the dewetting agents decompose to various gaseous products can be tailored by incorporation of accelerators and/or catalysts. In addition, activators may be co-deposited with the dewetting agent. Suitable activators for azodicarbonamide blowing agents, for example, include urea, zinc oxide, and zinc stearate.

After the coating 122 is cast onto the cover 120, the label 110 is then applied to the coating 122. Preferably, the label 110 is commercially available and its application method is conventional. For example, the label 110 may be a conventional pressure sensitive adhesive (PSA) label applied with a weighted roller. In general, the label substrate 111 of the label 110 maybe constructed from any suitable material (e.g., paper, plastic film, foil, and the like) that is acceptable for printing and that accepts an adhesive layer 112. The adhesive layer 112 is preferably a pressure sensitive adhesive, but alternatively may be any other type of conventional adhesive, such as a heat activatable adhesive, a rewettable type adhesive, a radiation (e.g., UV) curable adhesive, a solvent curable adhesive, or the like. Such labels are frequently attached to products, such as computers and other electronic devices, for purposes of information, safety and security.

To remove the label 110 from the cover 120 of the computer enclosure, a stream of hot air is directed at the surface to the label 110 and/or at the backside of the cover 120 in order to trigger the decomposition of the dewetting agent in the coating 122 at the interface between the label's adhesive layer 112 and the cover 120 in accordance with the preferred embodiments of the present invention. One skilled in the art will appreciate that other sources of heat (e.g., a hot plate, steam, hot water bath, etc.) may be employed to trigger the decomposition of the dewetting agent in lieu of, or in addition to, the stream of hot air. The gaseous decomposition products effectively serve to form bubbles at the interface thereby “lifting” the label 110 from the sheet metal or plastic that typically comprises the cover 120. Hence, when a computer that incorporates the cover 120 is eventually returned by the user for recycling, for example, the label 110 can be easily removed from the cover 120 through the application of heat which triggers decomposition of the primer coating's dewetting agent.

In at least the case of a security label, the ability to remove the label in a substantially intact state afforded by the utilization of a dewetting agent primer in accordance with the preferred embodiments of the present invention may itself present certain vulnerabilities. For example, a security label containing a serial number or other identifying indicia may be removed for nefarious reasons (e.g., a security label may be swapped for another, altered, or “lost”). Consequently, in certain cases it may be desirable to utilize a “tamper evident” label in combination with a dewetting agent primer in accordance with the preferred embodiments of the present invention. For example, a PSA label may incorporate an indicator material, such as a thermochromic dye, that changes appearance when the PSA label is exposed to a temperature approximately equal to the temperature which activates the dewetting agent primer. Thermochromic dyes are based on mixtures of leuco dyes with other chemicals that undergo a pH-sensitive absorption change with temperature. For example, microcapsules incorporating crystal violet lactone, a weak acid, and a dissociable salt dissolved in dodecanol, for example, undergo a color change when the solvent melts. In this case, the dye exists in its lactone leuco form at room temperature but when the solvent melts, the salt dissociates, the pH inside the microcapsule drops, the dye is protonated, the lactone ring opens, and its absorption spectrum shift drastically, imparting a deep violet color. The most commonly used dyes are spirolactones, fluorans, spiropyrans, and fulgides. The weak acids include bisphenol A, parabens, 1,2,3-triazole derivatives, and 4-hydroxycoumarin and act as proton donors, changing the dye molecule between its leuco form and its protonated colored form; stronger acids render the change irreversible. Hence, the use of a strong acid is preferred where an irreversible color change is desired.

In an illustrative example, the coating was applied onto a substrate (i.e., an aluminum test bar) by casting the dewetting agent (i.e., Celogen OT (which, as noted above, is a low temperature sulfonylhydrazide that decomposes at a temperature 160° C. and is commercially available from Chemura Corporation)) out of the solvent (i.e., toluene). The aluminum test bar was dip coated from a toluene dispersion of Celogen OT (5 wt %) at room temperature. Then, a label (i.e., 3M 300 LSE adhesive transfer tape (commercially available from 3M, located in St. Paul, Minn.)) was laminated onto the coating. The label was hand applied with minimal pressure (i.e., less than or equal to approximately 5 psi) at room temperature. Using identical procedures, an identical label was laminated onto an identical but uncoated aluminum test bar. Both of the aluminum test bars were subsequently heated (at 160° C.) on a hot plate for a brief period (60-120 seconds). Heat activation of the Celogen OT blowing agent resulted in massive bubble formation at the interface, which in turn resulted in a drastic decrease in bond strength of label. The label easily peeled off the aluminum test bar with the blowing agent primer; however, the label on the aluminum test bar without the blowing agent primer would not readily peel off and would leave remnants if scraped off with a straight edge razor.

Alternatively, or in addition, a coating having a dewetting agent in accordance with the preferred embodiments of the present invention may be applied directly onto at least a portion of the substrate that includes the adhesive. This alternative embodiment, which is described below with reference to FIGS. 4 and 5, is typically less preferable because of the greater likelihood of the coating undesirably interfering with adhesion prior to activation of the dewetting agent.

Reference is now made to FIGS. 4 and 5. FIG. 4 illustrates, in a cross-sectional view, a label 410 affixed to a cover 120 of a computer enclosure, wherein an adhesive layer 112 of the label 410 is provided with a coating 413 having a dewetting agent according to the preferred embodiments of the present invention. FIG. 5 illustrates, in a cross-sectional view, the coating 413 applied to the adhesive layer 112 of the label 410, prior to the application of the label 410 to the cover 120 of the computer enclosure. The coating 413 in FIGS. 4 and 5 includes the same constituents and is made in the same way as the coating 122 in FIGS. 1-3. As mentioned above, applying the coating 413 directly onto the adhesive layer 112 is typically less preferable (than applying the coating 122 directly on the cover 120 of the computer enclosure as shown in FIGS. 1-3) because of the greater likelihood of the coating 413 undesirably interfering with the adhesion of the adhesive layer 112 of the cover 120 prior to activation of the dewetting agent. Consequently, the coating 413 is typically applied so as to have a thickness that is relatively thin (relative to the coating 122 in FIGS. 1-3), i.e., preferably within the range of approximately 0.1-25.0 μm once the solvent has evaporated, and more preferably, within the range of approximately 0.5-10.0 μm.

As mentioned above, the present invention may be utilized at the interface between any two substrates. In another illustrative application of the present invention, a coating having a dewetting agent in accordance with the preferred embodiments of the present invention may be applied at the interface between an electromagnetic compatibility (EMC) gasket and a cover and/or frame of a computer enclosure. Such an illustrative application is described below with reference to FIG. 6.

FIG. 6 illustrates, in a cross-sectional view, an EMC gasket 610 affixed to a cover 120 of a computer enclosure, with a coating 122 having a dewetting agent interposed between the gasket's adhesive layer 612 and the cover 120. To remove the EMC gasket 610 from the cover 120 of the computer enclosure, a stream of hot air is directed at the surface of the EMC gasket 610 and/or at the backside of the cover 120 in order to trigger the decomposition of the dewetting agent in the coating 122 at the interface between the EMC gasket's adhesive layer 612 and the cover 120 in accordance with the preferred embodiments of the present invention. One skilled in the art will appreciate that other sources of heat (e.g., a hot plate, heat lamp, etc.) may be employed to trigger the decomposition of the dewetting agent in lieu of, or in addition to, the stream of hot air. The gaseous decomposition products effectively serve to form bubbles at the interface thereby “lifting” the EMC gasket 610 from the sheet metal or plastic that typically comprises the cover 120. Hence, when a computer that incorporates the cover 120 must be reworked during manufacture or is eventually returned by the user for recycling, the EMC gasket 610 can be easily removed from the cover 120 through the application of heat which triggers decomposition of the primer coating's dewetting agent. It is important to note that in accordance with the preferred embodiments of the present invention any type of dewetting agent may be used in the coating 122 at the interface between the EMC gasket 610 and the cover 120 in FIG. 6 Oust as described above with reference to the interface between the label 110 and the cover 120 in FIGS. 1-3), i.e., the dewetting agent need not be heat activated and need not decompose into gaseous products at a predefined temperature.

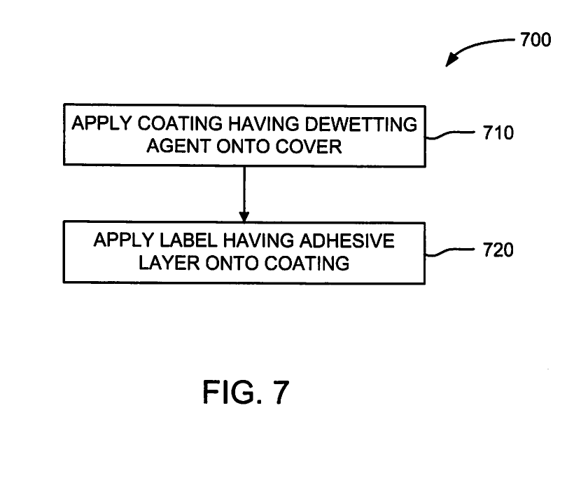

FIG. 7 is flow diagram illustrating a method 700 for applying a label to a cover of a computer enclosure, wherein a coating having a dewetting agent is interposed between the label's adhesive layer and the cover according to the preferred embodiments of the present invention. The method 700 begins with the application of a coating having a dewetting agent on the cover (step 710). The coating may be applied to the cover using a roller, for example. The method 700 continues with the application of a label having an adhesive layer onto the cover, with the coating being interposed between the label's adhesive layer and the cover (step 720). A conventional pressure sensitive adhesive (PSA) label, for example, may be applied onto the coating using a weighted roller.

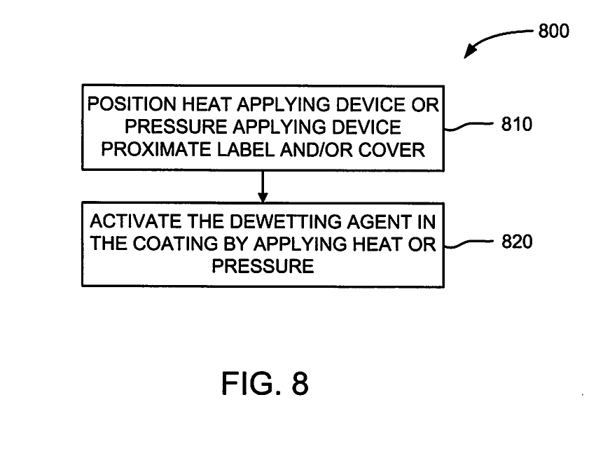

FIG. 8 is flow diagram illustrating a method 800 for removing a label from a cover of a computer enclosure by activating a dewetting agent in a coating interposed between the label's adhesive layer and the cover according to the preferred embodiments of the present invention. The method 800 begins by positioning at least one of a heat applying device and a pressure applying device proximate the label and/or cover (step 810). For example, a hot plate may be positioned over the label and another hot plate may be positioned over the cover. The method 800 continues with the activation of the dewetting agent of the coating by applying at least one of heat and pressure to the coating (step 820). For example, the coating may be activated by applying heat to drive the temperature of dewetting agent in the coating to a predetermined temperature at which the dewetting agent decomposes to various gaseous products. The gaseous decomposition products effectively serve to form bubbles at the interface thereby “lifting” the label from the cover. Hence, when a computer that incorporates the cover is eventually returned by the user for recycling, for example, the label can be easily removed from the cover through the application of heat which triggers decomposition of the dewetting agent.

One skilled in the art will appreciate that many variations are possible within the scope of the present invention. For example, although the preferred embodiments of the present invention are described herein within the context of a dewetting agent in a coating applied at: 1) the interface between a label and a cover of a computer enclosure; and 2) the interface between an electromagnetic compatibility (EMC) gasket and a cover of a computer enclosure; the present invention may be utilized at the interface between any two substrates. Thus, while the present invention has been particularly shown and described with reference to the preferred embodiments thereof, it will be understood by those skilled in the art that these and other changes in form and detail may be made therein without departing from the spirit and scope of the present invention.

What is claimed is:

1. An apparatus, comprising:
a first substrate;
an adhesive layer on the first substrate;
a second substrate;
a coating interposed between the adhesive layer and the second substrate, the coating including a dewetting agent.

2. The apparatus as recited in claim 1, wherein the dewetting agent is a material that thermally decomposes to form at least one gaseous product at a predefined temperature.

3. The apparatus as recited in claim 2, wherein the adhesive layer is a pressure sensitive adhesive (PSA) layer.

4. The apparatus as recited in claim 3, wherein the first substrate is a portion of a PSA label and the second substrate is a portion of a sheet metal surface and/or a plastic surface.

5. The apparatus as recited in claim 4, wherein the PSA label incorporates an indicator material that changes appearance when the PSA label is exposed to temperature approximately equal to the predefined temperature.

6. The apparatus as recited in claim 5, wherein the indicator material is a thermochromic dye.

7. The apparatus as recited in claim 3, wherein the first substrate is a portion of an electromagnetic compatibility (EMC) gasket and the second substrate is a portion of an enclosure for an electronic device.

8. The apparatus as recited in claim 2, wherein the dewetting agent is a plastic foaming agent selected from a group consisting of azo compounds, sulfonyl hydrazides, and combinations thereof.

9. The apparatus as recited in claim 8, wherein the plastic foaming agent includes an azodicarbonamide blowing agent.

10. The apparatus as recited in claim 9, wherein the coating includes an activator co-deposited with the azodicarbonamide blowing agent, the activator being selected from a group consisting of urea, zinc oxide, zinc stearate, and combinations thereof.

11. The apparatus as recited in claim 2, wherein the dewetting agent is calcium oxalate.

12. The apparatus as recited in claim 2, wherein the dewetting agent is encapsulated in microspheres.

13. The apparatus as recited in claim 1, wherein the dewetting agent is a silicone oil and/or an adhesive solvent encapsulated in microspheres, each microsphere having a shell that has a predetermined crush strength.

14. The apparatus as recited in claim 1, wherein the adhesive layer is a pressure sensitive adhesive (PSA) layer, wherein the first substrate is a portion of a PSA label, wherein the second substrate is a portion of a sheet metal surface and/or a plastic surface, and wherein the dewetting agent is a silicone oil and/or a PSA solvent encapsulated in microspheres, each microsphere having a shell that has a crush strength greater than the pressure required to apply the PSA label to the sheet metal and/or plastic surface.

15. The apparatus as recited in claim 1, wherein the dewetting agent is a gas encapsulated in expandable microspheres.

16. An apparatus, comprising:
a substrate;
an adhesive layer on the substrate;
a dewetting agent in the form of a constituent in a coating on the adhesive layer.

17. A method of applying a first substrate to a second substrate, the first substrate having an adhesive layer on a surface thereof, the method comprising the steps of:
providing a coating on the second substrate, the coating including a dewetting agent;
applying the first substrate to the second substrate with the adhesive layer and coating interposed therebetween.

18. The method as recited in claim 17, wherein the dewetting agent is a material that thermally decomposes to form at least one gaseous product at a predefined temperature.

19. The method as recited in claim 18, wherein the first substrate is one of a portion of a label or a portion of an electromagnetic compatibility (EMC) gasket.

20. A method of removing a first substrate from a second substrate affixed to the first substrate by an adhesive layer, wherein a coating that includes a dewetting agent is interposed between the second substrate and the adhesive layer, the method comprising the steps of:
positioning at least one of a heat applying device and a pressure applying device proximate at least one of the first substrate and the second substrate;
activating the dewetting agent of the coating by applying at least one of heat and pressure to the coating.

21. The method as recited in claim 20, wherein the dewetting agent is a material that thermally decomposes to form at least one gaseous product at a predefined temperature, and wherein the activating step includes the step of applying heat to the coating through at least one of the first substrate and the second substrate to drive the temperature of the dewetting agent to reach at least the predefined temperature, whereby bubbles formed through the decomposition of the dewetting agent lift the first substrate and the adhesive layer relative to the second substrate.

22. The method as recited in claim 21, wherein the first substrate is one of a portion of a label or a portion of an electromagnetic compatibility (EMC) gasket.
